(19) United States
(12) Patent Application Publication
(10) Pub. No.: US 2024/0030485 A1
(43) Pub. Date: Jan. 25, 2024

(54) SULFIDE SOLID ELECTROLYTE MATERIAL, GAS-PHASE SYNTHESIS METHOD FOR MATERIALS THEREOF AND APPLICATION THEREOF

(71) Applicants: Tianmu Lake Institute of Advanced Energy Storage Technologies Co. Ltd, Liyang, Jiangsu (CN); Institute of Physics, The Chinese Academy Of Sciences, Beijing (CN); Yangtze River Delta Physics Research Center Co. Ltd, Kunlun Street Liyang, Jiangsu (CN)

(72) Inventors: Fan Wu, Kunlun Street Liyang, Jiangsu (CN); Pushun LU, Beijing (CN); Hong Li, Kunlun Street Liyang, Jiangsu (CN)

(21) Appl. No.: 18/040,706

(22) PCT Filed: Dec. 21, 2020
(86) PCT No.: PCT/CN2020/137882

§ 371 Date: Feb. 6, 2023

(30) Foreign Application Priority Data
Aug. 8, 2020 (CN) 202010792068.3

(51) Int. Cl. H01M 10/0562; C01G 19/00; C01G 30/00; C01G 1/12; C01B 17/22; H01M 10/052; H01M 4/58; H01M 4/136

(52) U.S. Cl. CPC H01M 10/0562; C01G 19/006; C01G 30/002; C01G 1/12; C01B 17/22; H01M 10/052; H01M 4/5815; H01M 4/136; C01P 2002/72; C01P 2006/40; H01M 2300/0068

(57) ABSTRACT

A sulfide solid electrolyte material, a gas-phase synthesis method for materials thereof and an application thereof are disclosed. The gas-phase synthesis method comprises: weighing a Li source and an M source according to a defined ratio, the M source being an oxide or sulfide of at least one of group 4, 5, 6, 13, 14 and 15 elements from the third period to the sixth period in the periodic table of elements; mixing and placing the mixed raw materials into a furnace; adding an S source into a sulfur source gas generation device; using a carrier gas, and performing gas washing on the furnace for a certain duration at a set ventilation rate; heating the furnace to 200-800° C. at a set heating rate in an environment in which the gas containing the S source is introduced at the set ventilation rate, keeping warm for a set duration, and then cooling to room temperature; and removing a sulfide solid electrolyte from the furnace.

### CROSS-REFERENCE TO RELATED APPLICATIONS

This application is a national phase entry under 35 U.S.C. § 371 of International Patent Application PCT/CN2020/137882, filed Dec. 21, 2020, designating the United States of America and published as International Patent Publication WO 2022/032956 A1 on Feb. 17, 2022, which claims the benefit under Article 8 of the Patent Cooperation Treaty to Chinese Patent Application No. 202010792068.3, filed on Aug. 8, 2020 and titled “GAS PHASE SYNTHESIS METHOD FOR SULFIDE SOLID ELECTROLYTE MATERIAL, AND RAW MATERIALS THEREOF, AND APPLICATION THEREOF.”

### TECHNICAL FIELD

The disclosure relates to the technical field of materials, and in particular, to methods for sulfide solid-electrolyte material, gas phase synthesis method for raw materials thereof, and application.

### BACKGROUND

Due to the upper limit “bottleneck” of 350 Wh/kg in terms of energy density and the occurrence of potential safety hazards such as spontaneous combustion, ignition, and explosion, a traditional lithium-ion battery using a liquid electrolyte and a carbon negative electrode has been unable to meet the high requirements for indicators such as battery energy density and safety performance in fields such as electric vehicles and energy storage grids.

Compared with the liquid electrolyte, solid electrolyte has high thermal stability and compactness. Therefore, an all-solid-state battery assembled from the solid electrolyte, instead of the liquid electrolyte, and diaphragms will be greatly improved in terms of safety. At the same time, lithium metal can be used as the negative electrode of the all-sold-state battery, such that the energy density of the battery is expected to increase by 40% to 50% under the same positive electrode system. The all-solid-state batteries are classified based on the solid electrolytes used, and are mainly developed following the routes of polymer, oxide, and sulfide all-solid-state batteries. A sulfide electrolyte has become one of the research focuses in the field of all-solid-state batteries due to its high ionic conductivity (for example, the lithium-ion conductivities of Li₁₀GeP₂S₁₂ and Li_{9.54}Si_{1.74}P_{1.44}S_{11.7}Cl_{0.3} at room temperature reach 12 mS/cm and 25 mS/cm, respectively) comparable to or even surpassing that of the liquid electrolyte, and excellent mechanical ductility (a battery can be assembled just by cold pressing at room temperature).

The method for synthesizing the sulfide electrolyte directly affects the capacity of producing the sulfide electrolyte on an industrial scale in the future. At present, a sulfide solid electrolyte is synthesized commonly through solid phase methods (including high-temperature solid phase methods and mechano-chemical methods) and liquid phase methods. The solid phase methods include: first, mixing an Li source, an S source, a P source, and other raw materials in a manner of mortar grinding or ball milling with a ball mill; and second, pressing mixed powder into sheets, and sintering the sheets in a vacuum sealed tube or under the protection of an inert atmosphere, or directly sintering the powder in a vacuum sealed tube or under the protection of an inert atmosphere, at a temperature of 100° C.-700° C. for more than 20 hours in general. The liquid phase methods include: adding the powder of raw materials such as an Li source, an S source, and a P source to an organic solvent; sequentially performing stirring and mixing, centrifuging, filtering, and drying to obtain a precursor; and then performing heat treatment at certain temperature to obtain a final product of the sulfide electrolyte.

Patent CN108878962A indicates that when the ball milling method is used, raw materials and abrasives need to be placed in a sealed container free of water and oxygen to reduce side reactions with air and moisture, thereby improving the performance of the sulfide solid electrolyte.

Patent CN110165293A also indicates that the moisture content of an organic solvent and the moisture content in an operating environment need to be considered.

Patent CN108352567A synthesizes Li₁₃Sn₂InS₁₂, an air-stable sulfide electrolyte free of a P element. However, raw materials used include expensive lithium sulfide, and meanwhile, vacuum tube sealing, multi-step heat treatment and long-term sintering are still needed during a synthesis process. Both the solid phase methods and the liquid phase methods need to use air-sensitive/air-instable sulfides Li₂S, P₂S₅, SiS₂, and Al₂S₃, hygroscopic and deliquescent halides LiCl, LiBr, and LiI, and the like as starting materials (of which Li₂S and SiS₂ are expensive), and the whole preparation process needs to be performed under the conditions of air isolation and inert atmosphere protection. In the solid phase methods, long-term ball milling, high-pressure sheeting, vacuum tube sealing, and long-term sintering are required.

Accordingly, the solid phase methods have the disadvantages of many process steps, complex operation, large time consumption, large energy consumption, high cost, and the need for vacuum environment or inert atmosphere protection during the whole process. The liquid phase methods also require long-term heating and stirring, solid-liquid separation, long-term drying, and heat treatment. Accordingly, the liquid phase methods also have the disadvantages of many process steps, large time consumption, high cost, and the need for vacuum environment or inert atmosphere protection during the whole process. Furthermore, the liquid phase methods also have the disadvantage that the introduced solvent is difficult to remove, which seriously affects the ionic conductivity of the sulfide electrolyte. Due to the need for vacuum environment or inert atmosphere protection during the preparation process, both methods can hardly compatible with existing the existing process lines and equipment for lithium batteries in a dry-room environment.

Patent CN103098288A discloses the growth of identical or different sulfide dense membrane layers on a sulfide powder forming layer by a gas phase method. For example, a sulfide electrolyte with a low boiling point is deposited by evaporation on a substrate of a sulfide powder forming layer that has been cold-pressed, in order to form a denser membrane layer. Therefore, there is no real synthesis of a sulfide solid electrolyte by using the gas phase method at present.

### BRIEF SUMMARY

Embodiments of the disclosure provide methods for gas phase synthesis of a sulfide solid-electrolyte material and a raw material thereof, and its application. The methods use air-stable and low-cost raw materials to synthesize the sulfide solid-electrolyte material in one step by a gas phase method, greatly simplifying the process steps and the operating complexity and showing low requirements for synthesis equipment. The methods are suitable for large-scale process production.

In a first aspect, an embodiment of the disclosure provides a method for gas phase synthesis of a sulfide solid-electrolyte material. The method includes:
weighing out an Li source and an M source, as raw materials, according to a desired ratio, then mixing the Li source and the M source, and putting the mixed raw materials into a heating furnace, wherein the Li source includes at least one of Li₂CO₃, Li₂O, Li₂S, LiOH, LiCl, lithium acetate, lithium sulfate, lithium nitrate, or lithium metal, and the M source is at least one of an elementary substance of an M element, an oxide of the M element, and a sulfide of the M element, with the M element being at least one selected from elements of Groups 4, 5, 6, 13, 14, and 15 in the periodic table of the elements from Period 3 to Period 6;
adding an S source to a sulfur-source gas generation device, wherein the S source includes one or more of an S-containing gas, a sulfur-containing organic compound, a polysulfide, a sulfate, or a metal sulfide; connecting a carrier gas generation device, a gas flow meter, the sulfur-source gas generation device, the heating furnace, and a tail gas treatment device in sequence to form a gas phase synthesis device;
carrying a gas containing the S source by a carrier gas, and performing gas washing on the heating furnace for a certain period of time at a set ventilation rate;
after the gas washing is completed, heating the heating furnace to 200° C.-800° C. at a set heating rate in an environment in which the gas containing the S source is introduced at a set ventilation rate, holding the temperature for a set period of time, and then cooling to room temperature; and
after the cooling, removing a substance, namely, a sulfide solid electrolyte, from the heating furnace.

Preferably, the M element includes: at least one of Sn, Sb, As, P, Si, Ge, and Bi; the M source includes: at least one of an Sn source, an Sb source, an As source, a P source, an Si source, a Ge source, and a Bi source; the Sn source includes: at least one of elemental Sn, SnO₂, SnS₂, SnCl₄, and their hydrates; the Sb source includes: at least one of elemental Sb, Sb₂O₅, Sb₂O₃, Sb₂S₅, and Sb₂S₃; the As source includes: at least one of elemental As, As₂O₅, As₂O₃, As₂S₅, and As₂S₃; the P source includes: at least one of elemental P, P₂S₃, P₂S₅, and P₂O₅; an Si source includes: at least one of elemental Si, SiO, SiO₂, SiS₂, SiCl₄, and their hydrates; a Ge source includes: at least one of elemental Ge, GeO₂, GeS, GeS₂, GeCl₄, and their hydrates; and a Bi source includes: at least one of elemental Bi, Bi₂O₃, Bi₂S₃, and Bi(OH)₃.

The S-containing gas includes: at least one of hydrogen sulfide, sulfur dioxide, sulfur trioxide, sulfur-containing natural gas, sulfur vapor, and carbon disulfide vapor.

The sulfur-containing organic compound includes: at least one of methyl mercaptan, methyl sulfide, dimethyl disulfide, thiophene, ethanethiol, ethyl sulfide, methyl ethyl sulfide, and thiourea.

The carrier gas is any one of nitrogen (N₂), carbondioxide (CO₂), and an argon (Ar) gas.

Preferably, a method for the mixing comprises:
mortar grinding or mechanical mixing;
a time for the mortar grinding is within a range from 10 minutes to 120 minutes; and
the mechanical mixing includes performing mechanical mixing by using a roller mill, a ball mill, or a spray mill, for a mixing time within a range of 1 hour to 8 hours.

Preferably, the certain period of time is within a range from 10 minutes to 120 minutes; the set period of time is within a range from 10 hours to 72 hours.

The set heating rate is within a range from 1° C./minute to 10° C./minute; the cooling is performed at a set cooling rate, or by natural cooling, with the set cooling rate being in a range from 1° C./minute to 10° C./minute.

The set ventilation rate is within a range from 1 ml/minute to 30 ml/minute.

In a second aspect, an embodiment of the disclosure provides a method for gas phase synthesis of a raw material for a sulfide solid-electrolyte material, wherein the raw material for the sulfide solid-electrolyte material has a chemical formula of AₓS_{y}, with A being any one of Li, Si, Ge, Sn, P, As, Sb, and Bi, 0<x≤2, and 0<y≤5; and the method for gas phase synthesis includes:
weighing out an A source according to a desired amount, and then putting the A source into a heating furnace, the A source including at least one of an oxide of A, a hydroxide of A, a carbonate of A, and elemental A;
adding an S source to a sulfur-source gas generation device, wherein the S source includes one or more of an S-containing gas, a sulfur-containing organic compound, a polysulfide, a sulfate, or a metal sulfide;
connecting a carrier gas generation device, a gas flow meter, the sulfur-source gas generation device, the heating furnace, and a tail gas treatment device in sequence to form a gas phase synthesis device;
carrying a gas containing the S source by a carrier gas, and performing gas washing on the heating furnace for a certain period of time at a set ventilation rate;
after the gas washing is completed, heating the heating furnace to 200° C.-800° C. at a set heating rate in an environment in which the gas containing the S source is introduced at a set ventilation rate, holding the temperature for a set period of time, and then cooling to room temperature; and
after the cooling, removing a substance, namely, the raw material for the sulfide solid electrolyte, from the heating furnace.

Preferably, the carrier gas includes any one of nitrogen (N₂), carbondioxide (CO₂), and argon (Ar) gas.

The S-containing gas includes: at least one of hydrogen sulfide, sulfur dioxide, sulfur trioxide, sulfur-containing natural gas, sulfur vapor, and carbon disulfide vapor.

The sulfur-containing organic compound includes: at least one of methyl mercaptan, methyl sulfide, dimethyl disulfide, thiophene, ethanethiol, ethyl sulfide, methyl ethyl sulfide, and thiourea.

Preferably, the certain period of time is within a range from 10 minutes to 120 minutes; the set period of time is within a range from 10 hours to 72 hours.

The set heating rate is within a range from 1° C./minute to 10° C./minute; the cooling is performed at a set cooling rate, or by natural cooling, with the set cooling rate being in a range from 1° C./minute to 10° C./minute.

The set ventilation rate is within a range from 1 ml/minute to 30 ml/minute.

In a third aspect, an embodiment of the disclosure provides a sulfide solid-electrolyte material synthesized based on the method for gas phase synthesis described in the first aspect above, wherein the sulfide solid-electrolyte material is used as an electrode material of a lithium battery.

In a fourth aspect, an embodiment of the disclosure provides a raw material for a sulfide solid-electrolyte material synthesized based on the method for gas phase synthesis described in the second aspect above, wherein the raw material is used for synthesizing the sulfide solid-electrolyte material described in the third aspect above.

In a fifth aspect, an embodiment of the disclosure provides a lithium battery, which includes the sulfide solid-electrolyte material synthesized based on the method for gas phase synthesis described in the first aspect above.

The method for gas phase synthesis of the sulfide solid-electrolyte material according to the disclosure uses air-stable and low-cost raw materials to synthesize the sulfide solid-electrolyte material in one step by a gas phase method, greatly simplifying the process steps and the operating complexity and showing low requirements for synthesis equipment. The method is suitable for large-scale process production. Due to the use of air-stable raw materials and the good air stability of the synthesized sulfide solid-electrolyte material, the method for synthesis does not need to be performed under the condition of a vacuum environment or with the protection of an inert atmosphere, and can be performed directly in an air environment (moist air and dry air in a dry room), such that the air stability is achieved throughout the process of preparing the sulfide solid-electrolyte material from raw materials to a final reaction product, and the compatibility with the existing process lines and equipment for producing lithium batteries in a dry room environment is achieved. Further, the disclosure fundamentally solves the problem of strict requirements for the environmental atmosphere during production and preparation, storage, transportation, and usage of the sulfide solid-electrolyte materials, greatly promoting the application of the sulfide solid-electrolyte materials.

### BRIEF DESCRIPTION OF THE DRAWINGS

The technical solutions of the embodiments of the disclosure will be further described below in combination with the accompanying drawings and embodiments.

FIG. 1 shows a flowchart of a method for gas phase synthesis of a sulfide solid-electrolyte material according to an embodiment of the disclosure;

FIG. 2 shows a schematic structural diagram of a gas phase synthesis device according to an embodiment of the disclosure;

FIG. 3 shows a flowchart of a method for gas phase synthesis of a raw material for a sulfide solid-electrolyte material according to an embodiment of the disclosure;

FIG. 4 shows the comparison of X-ray diffraction (XRD) patterns of sulfide solid electrolytes Li₄SnS₄Li_{3.85}Sn_{0.85}Sb_{0.15}S₄, Li_{3.8}Sn_{0.8}As_{0.2}S₄, and Li₄Sn_{0.9}Si_{0.1}S₄, as Li—Sn—S system crystals, prepared according to Examples 1, 2, 3 and 4 of the disclosure, with a PDF card 04-019-27403 of Li₄SnS₄ of an orthorhombic crystal system;

FIG. 5 shows the electrochemical impedance spectra (EIS) of sulfide solid electrolytes Li₄SnS₄Li_{3.85}Sn_{0.85}Sb_{0.15}S₄, Li_{3.8}Sn_{0.8}As_{0.2}S₄, and Li₄Sn_{0.9}Si_{0.1}S₄, as Li—Sn—S system crystals, prepared according to Examples 1, 2, 3 and 4 of the disclosure;

FIG. 6 shows the Arrhenius curves and calculated activation energy of sulfide solid electrolytes Li₄SnS₄ and Li_{3.85}Sn_{0.85}Sb_{0.15}S₄, as Li—Sn—S system crystals, prepared according to Examples 1 and 2 of the disclosure;

FIG. 7 shows an XRD pattern of a P-containing sulfide solid electrolyte Li₁₀SnP₂S₁₂ prepared according to Example 5 of the disclosure;

FIG. 8 shows the Arrhenius curve and calculated activation energy of a P-containing sulfide solid electrolyte Li₁₀SnP₂S₁₂ prepared according to Example 5 of the disclosure;

FIG. 9 shows the comparison of the XRD pattern of a raw material Li₂S for a solid electrolyte material prepared according to Example 6 of the disclosure, with a PDF card 65-2981 of Li₂S; and

FIG. 10 shows the initial cycle charging and discharging curves of an all-solid-state battery, assembled by using electrolyte Li_{3.8}Sn_{0.8}As_{0.2}S₄ prepared in Example 3 of the disclosure, according to Example 7 of the disclosure.

### DETAILED DESCRIPTION

The present invention is further explained below by means of the accompanying drawings and specific embodiments. However, it should be understood that these embodiments are merely for the purpose of more detailed explanation, and should not be understood as limiting the present invention in any form, that is, these embodiments are not intended to limit the protection scope of the present invention.

The method of gas phase synthesis for a sulfide solid-electrolyte material of the disclosure includes the main method steps as shown in the flowchart of FIG. 1. The method will be introduced below in combination with the flowchart.

The method of gas phase synthesis for a sulfide solid-electrolyte material of the disclosure mainly includes the steps below.

In step 110, a lithium source (“Li source”) and an M source are weighed out as raw materials according to a desired ratio, then mixed, and put into a heating furnace.

The Li source includes at least one of Li₂CO₃, Li₂O, Li₂S, LiOH, LiCl, lithium acetate, lithium sulfate, lithium nitrate, or lithium metal.

The M source is at least one of an elementary substance of an M element, an oxide of the M element, and a sulfide of the M element, with the M element being at least one selected from elements of Groups 4, 5, 6, 13, 14, and 15 in the periodic table of the elements from Period 3 to Period 6. Preferably, the M element may be at least one of tin (Sn), antimony (Sb), arsenic (As), and phosphorus (P). That is, the M source is preferably at least one of the tin (Sn) source, the antimony (Sb) source, the arsenic (As) source, and the phosphorus (P) source. Further specifically, the tin (Sn) source includes: at least one of elemental Sn, SnO₂, SnS₂, SnCl₄, and their hydrates; the antimony (Sb) source includes: at least one of elemental Sb, Sb₂O₅, Sb₂O₃, Sb₂S₅, and Sb₂S₃; the arsenic (As) source includes: at least one of elemental As, As₂O₅, As₂O₃, As₂S₅, and As₂S₃; the phosphorus (P) source includes: at least one of elemental P, P₂S₃, P₂S₅, and P₂O₅; a silicon (Si) source includes: at least one of elemental Si, SiO, SiO₂, SiS₂, SiCl₄, and their hydrates; a germanium (Ge) source includes: at least one of elemental Ge, GeO₂, GeS, GeS₂, GeCl₄, and their hydrates; and a bismuth (Bi) source includes: at least one of elemental Bi, Bi₂O₃, Bi₂S₃, and Bi(OH)₃.

A method for the mixing specifically includes mortar grinding or mechanical mixing. A time for the mortar grinding is within a range from 10 minutes to 120 minutes; and the mechanical mixing includes performing mechanical mixing by using a roller mill, a ball mill, or a spray mill, for a mixing time within a range of 1 hour to 8 hours.

In step 120, a sulfur (S) source is added to a sulfur-source gas generation device.

The S source includes one or more of an S-containing gas, a sulfur-containing organic compound, a polysulfide, a sulfate, or a metal sulfide. Further specifically, the S-containing gas includes: at least one of hydrogen sulfide, sulfur dioxide, sulfur trioxide, sulfur-containing natural gas, sulfur vapor, and carbon disulfide vapor.

The sulfur-containing organic compound includes: at least one of methyl mercaptan, methyl sulfide, dimethyl disulfide, thiophene, ethanethiol, ethyl sulfide, methyl ethyl sulfide, and thiourea.

In the S source, the polysulfide may be decomposed in an acidic solution to produce H₂S and S; the sulfate may be thermochemically reduced with an organic matter to produce H₂S; and the metal sulfide may react with hydrochloric acid or sulfuric acid to produce H₂S. Consequently, the gas containing the S source that can be carried by the carrier gas is produced.

In step 130, a carrier gas generation device, a gas flow meter, the sulfur-source gas generation device, the heating furnace, and a tail gas treatment device are connected in sequence to form a gas phase synthesis device.

FIG. 2 shows a schematic structural diagram of a specific gas phase synthesis device.

In the figure, the carrier gas provided in the carrier gas generation device is high-purity nitrogen, and an output of the carrier gas generation device is connected to the flow meter to adjust the flow rate of the carrier gas, and then is led to the sulfur-source gas generation device. In this embodiment, the sulfur-source gas generation device is shown with carbon disulfide housed in a bottle.

A gas output of the sulfur-source gas generation device is connected to an input of the heating furnace. In step 110, the mixed raw materials of the lithium (Li) source and the M source are placed in the heating furnace in advance. Specifically, the heating furnace may be a tube heating furnace, in which case the mixed raw materials are first placed in a crucible and then delivered into a quartz tube of the tube heating furnace.

Finally, a tail gas from the heating furnace is lead to tail gas treatment.

In step 140, a gas containing the sulfur (S) source is carried by a carrier gas, and gas washing is performed on the heating furnace for a certain period of time at a set ventilation rate.

Specifically, in order to ensure a reaction environment is achieved within the heating furnace, it is necessary to introduce a gas of the S source or a carrier gas containing the S source in advance to perform gas washing on the heating furnace for a period of time. The time for gas washing is preferably within a range from 10 minutes to 120 minutes.

In a specific embodiment, any of nitrogen (N₂), carbondioxide (CO₂), argon (Ar) and other gases may be specifically used as the carrier gas. The set ventilation rate is specifically within a range from 1 ml/minute to 30 ml/minute.

In step 150, after the gas washing is completed, the heating furnace is heated to 200° C.-800° C. at a set heating rate in an environment in which the gas containing the S source is introduced at a set ventilation rate, the temperature is held for a range from 10 hours to 72 hours, and then the furnace is cooled to room temperature.

Specifically, ventilation conditions are the same as the steps of gas washing.

The set heating rate is within a range from 1° C./minute to 10° C./minute.

The cooling can be specifically performed at a set cooling rate within a range of 1° C./minute to 10° C./minute, or by natural cooling.

In this step, the gas containing the S source reacts with the mixed raw materials of the Li source and the M source. Taking an oxide of M as the M source and CS₂ as the S source by way of example, the vulcanization reaction mechanism of CS₂ is as follows: C═S in CS₂ is weaker than C═O, such that C═S is liable to be attacked by O in the oxide raw materials to further produce C═O, in which case C leaves in the form of CO₂ gas, while S in C═S forms an elementary substance or binds to M in the oxide raw materials, and finally produces a sulfide electrolyte under a heating condition.

In step 160, after the cooling, a product, namely, a sulfide solid electrolyte, is removed from the heating furnace.

Preferably, the resulting product is placed in a glove box and then stored in an inert atmosphere, a vacuum environment, or a dry room with a dew point of −50° C.

The technical solution of the method for gas phase synthesis according to the disclosure facilitates the synthesis at the temperature of about 500° C. by optimizing the gas flow value (achieved by precisely adjusting the gas flow meter), the size of pipelines of the heating furnace, the heating and cooling rates and other parameters, whereby the measured yield is close to 100%, and 2 g of materials can be synthesized in a single batch in the laboratory.

The sulfide solid-electrolyte material synthesized with the above method for gas phase synthesis can be used in electrode materials, including positive and negative electrode materials, for lithium batteries.

In addition to the synthesis of the sulfide solid-electrolyte material, the above method for gas phase synthesis can be used to synthesize a raw material for the sulfide solid-electrolyte material. The synthesized raw material for the sulfide solid-electrolyte material has a chemical formula of AₓS_{y}, with A being any one of lithium (Li), silicon (Si), germanium (Ge), tin (Sn), phosphorus (P), arsenic (As), antimony (Sb), and bismuth (Bi), wherein 0<x≤2, and 0<y≤5. For example, Li₂S and other materials that are expensive at present can be synthesized with the present method.

The following is explained in combination with the flowchart of the method for gas phase synthesis of a raw material for a sulfide solid-electrolyte material as shown in FIG. 3.

In step 210, an A source is weighed out according to a desired amount, and then put into the heating furnace.

The A source includes an oxide of A, a hydroxide of A, a carbonate of A, or elemental A.

For example, the A source is the lithium (Li) source, including at least one of Li₂CO₃, Li₂O, LiOH, or lithium metal. AₓS_{y} is Li₂S.

For example, the A source is the silicon (Si) source, including elemental Si, SiO₂, and SiO. AₓS_{y} is SiS₂.

For example, the A source is the germanium (Ge) source, including elemental Ge and GeO₂. AₓS_{y} is GeS₂.

For example, the A source is the tin (Sn) source, including elemental Sn, SnO₂, and Sn₂O₃; and AₓS_{y} is SnS₂.

For example, the A source is the phosphorus (P) source, including elemental P, P₂O₃, and P₂O₅; and AₓS_{y} is P₂S₅.

For example, the A source is the arsenic (As) source, including elemental As, As₂O₅, and As₂O₃; and AₓS_{y} is As₂S₃ and/or As₂S₅.

For example, the A source is the antimony (Sb) source, including elemental Sb, Sb₂O₃, and Sb₂O₅; and AₓS_{y} is Sb₂S₃ and/or Sb₂S₅.

For example, the A source is the bismuth (Bi) source, including elemental Bi and Bi₂O₃; and AₓS_{y} is Bi₂S₃.

In step 220, a sulfur (S) source is added to a sulfur-source gas generation device.

The S source specifically includes one or more of an S-containing gas, a sulfur-containing organic compound, a polysulfide, a sulfate, or a metal sulfide. Further specifically, the S-containing gas includes: at least one of hydrogen sulfide, sulfur dioxide, sulfur trioxide, sulfur-containing natural gas, sulfur vapor, and carbon disulfide vapor.

The sulfur-containing organic compound includes: at least one of methyl mercaptan, methyl sulfide, dimethyl disulfide, thiophene, ethanethiol, ethyl sulfide, methyl ethyl sulfide, and thiourea.

In the S source, the polysulfide may be decomposed in an acidic solution to produce H₂S and S; the sulfate may be thermochemically reduced with an organic matter to produce H₂S; and the metal sulfide may react with hydrochloric acid or sulfuric acid to produce H₂S. Consequently, the gas containing the S source that can be carried by the carrier gas is produced.

In step 230, a carrier gas generation device, a gas flow meter, the sulfur-source gas generation device, the heating furnace, and a tail gas treatment device are connected in sequence to form a gas phase synthesis device.

The gas phase synthesis device in this embodiment is the same as that in the previous embodiment, and will not be repeated.

In step 240, a gas containing the S source is carried by a carrier gas, and gas washing is performed on the heating furnace for a certain period of time at a set ventilation rate.

The specific process is the same as step 140, and will not be repeated.

In step 250, after the gas washing is completed, the heating furnace is heated to 200° C.-800° C. at a set heating rate in an environment in which the gas containing the S source is introduced at a set ventilation rate, the temperature was held for a set period of time, and then the furnace is cooled to room temperature.

Specifically, ventilation conditions are the same as the steps of gas washing.

The set heating rate is within a range from 1° C./minute to 10° C./minute.

The cooling can be specifically performed at a set cooling rate within a range of 1° C./minute to 10° C./minute, or by natural cooling.

In step 260, after the cooling, a substance, namely, the raw material for the sulfide solid electrolyte, is removed from the heating furnace.

By means of the above method, raw materials such as Li2S for the synthesis of the sulfide solid-electrolyte materials can be prepared, whereby the problem that these raw materials are expensive and difficult to obtain is solved.

In order to better understand the technical solutions provided by the disclosure, a plurality of specific examples are described below to illustrate the specific processes and material characteristics of the sulfide solid-electrolyte materials synthesized using the methods provided in the aforementioned embodiments of the disclosure.

### Example 1

In this example, low-cost Li₂CO₃, CS₂, and SnO₂ that had been commercialized were selected as a lithium (Li) source, a sulfur (S) source, and a tin (Sn) source, respectively, to synthesize a sulfide electrolyte Li₄SnS₄. The specific steps were as follows:
(1) Li₂CO₃ and SnO₂ were weighed out as raw materials according to a desired ratio, and were ground for 30 minutes in a mortar to obtain powder with a total mass of 2 g, and the powder was put into two alumina crucibles (1 g per crucible);
(2) 80 mL of a CS₂ liquid was added to a gas-washing bottle with a capacity of 100 mL;
(3) the two crucibles containing the raw materials in step (1) were put, side by side, into the center of a quartz tube of a tube furnace, directly opposing a thermocouple;
(4) a nitrogen cylinder, a gas flow meter, the gas washing bottle, the tube furnace, and a tail gas bottle were connected in sequence by using silicone hoses, and both ends of the quartz tube of the tube furnace were each connected with a flange;
(5) a knob of the gas flow meter was adjusted to regulate the ventilation rate to 10 mL/minute, and gas washing was performed for about 60 minutes in advance;
(6) after the gas washing in step (5) was completed, the tube furnace was heated from the room temperature of 30° C. to 500° C. at a heating rate of 5° C./minute under the same ventilation condition, the temperature was held for 24 hours, and then cooling was performed at a cooling rate of 2° C./minute; and
(7) after the cooling was completed, the flange at one end of the quartz tube was detached, and the crucibles were taken out to obtain the solid electrolyte Li₄SnS₄.

The solid electrolyte Li₄SnS₄ obtained in this example has good air stability. After being exposed to and absorbing water in moist air, the solid electrolyte Li₄SnS₄ can be heated to remove water/crystal water, thereby restoring an original crystal structure.

### Example 2

In this example, low-cost Li₂CO₃, CS₂, SnO₂, and Sb₂O₅ that had been commercialized were selected as an Li source, an S source, an Sn source, and an Sb source, respectively, to synthesize a sulfide electrolyte Li_{3.85}Sn_{0.85}Sb_{0.15}S₄. The specific steps were as follows:
(1) Li₂CO₃, SnO₂, and Sb₂O₅ were weighed out as raw materials according to a desired ratio, and were ground for 30 minutes in a mortar to obtain powder with a total mass of 1 g, and the powder was put into an alumina crucible;
(2) 80 mL of a CS₂ liquid was added to a gas-washing bottle with a capacity of 100 mL;
(3) the crucible containing the raw materials in step (1) was put into the center of a quartz tube of a tube furnace, directly opposing a thermocouple;
(4) a nitrogen cylinder, a gas flow meter, the gas washing bottle, the tube furnace, and a tail gas bottle were connected in sequence by using silicone hoses, and both ends of the quartz tube of the tube furnace were each connected with a flange;
(5) a knob of the gas flow meter was adjusted to regulate the ventilation rate to 10 mL/minute, and gas washing was performed for about 60 minutes in advance;
(6) after the gas washing in step (5) was completed, the tube furnace was heated from the room temperature of 30° C. to 500° C. at a heating rate of 5° C./minute under the same ventilation condition, the temperature was held for 24 hours, and then cooling was performed at a cooling rate of 2° C./minute; and
(7) after the cooling was completed, the flange at one end of the quartz tube was detached, and the crucible was taken out to obtain the solid electrolyte Li_{3.85}Sn_{0.85}Sb_{0.15}S₄.

The solid electrolyte Li_{3.85}Sn_{0.85}Sb_{0.15}S₄ obtained in this example has good air stability. After being exposed to and absorbing water in moist air, the solid electrolyte Li_{3.85}Sn_{0.85}Sb_{0.15}S₄ can be heated to remove water/crystal water, thereby restoring an original crystal structure.

### Example 3

In this example, low-cost Li₂CO₃, CS₂, SnO₂, and As₂S₃ that had been commercialized were selected as a lithium (Li) source, sulfur (S) source, a tin (Sn) source, and an arsenic (As) source, respectively, to synthesize a sulfide electrolyte Li_{3.8}Sn_{0.8}As_{0.2}S₄. The specific steps were as follows:
(1) Li₂CO₃, SnO₂, and As₂S₃ were weighed out as raw materials according to a desired ratio, and were ground for 30 minutes in a mortar to obtain powder with a total mass of 1 g, and the powder was put into an alumina crucible;
(2) 80 mL of a CS₂ liquid was added to a gas-washing bottle with a capacity of 100 mL;
(3) the crucible containing the raw materials in step (1) was put into the center of a quartz tube of a tube furnace, directly opposing a thermocouple;
(4) a nitrogen cylinder, a gas flow meter, the gas washing bottle, the tube furnace, and a tail gas bottle were connected in sequence by using silicone hoses, and both ends of the quartz tube of the tube furnace were each connected with a flange;
(5) a knob of the gas flow meter was adjusted to regulate the ventilation rate to 10 mL/minute, and gas washing was performed for about 60 minutes in advance;
(6) after the gas washing in step (5) was completed, the tube furnace was heated from the room temperature of 30° C. to 500° C. at a heating rate of 5° C./minute under the same ventilation condition, the temperature was held for 24 hours, and then the furnace was cooled naturally; and
(7) after the cooling was completed, the flange at one end of the quartz tube was detached, and the crucible was taken out to obtain the solid electrolyte Li_{3.8}Sn_{0.8}As_{0.2}S₄.

The solid electrolyte Li_{3.8}Sn_{0.8}As_{0.2}S₄ obtained in this example has good air stability. After being exposed to and absorbing water in moist air, the solid electrolyte Li_{3.8}Sn_{0.8}As_{0.2}S₄ can be heated to remove water/crystal water, thereby restoring an original crystal structure.

### Example 4

In this example, low-cost Li₂CO₃, CS₂, SnO₂, and micron-sized elemental silicon powder that had been commercialized were selected as a lithium (Li) source, a sulfur (S) source, a tin (Sn) source, and a silicon (Si) source, respectively, to synthesize a sulfide electrolyte Li₄Sn_{0.9}Si_{0.1}S₄. The specific steps were as follows:
(1) Li₂CO₃, SnO₂, and Si were weighed out as raw materials according to a desired ratio, and were ground for 30 minutes in a mortar to obtain powder with a total mass of 1 g, and the powder was put into an alumina crucible;
(2) 80 mL of a CS₂ liquid was added to a gas-washing bottle with a capacity of 100 mL;
(3) the crucible containing the raw materials in step (1) was put into the center of a quartz tube of a tube furnace, directly opposing a thermocouple;
(4) a nitrogen cylinder, a gas flow meter, the gas washing bottle, the tube furnace, and a tail gas bottle were connected in sequence by using silicone hoses, and both ends of the quartz tube of the tube furnace were each connected with a flange;
(5) a knob of the gas flow meter was adjusted to regulate the ventilation rate to 10 mL/minute, and gas washing was performed for about 60 minutes in advance;
(6) after the gas washing in step (5) was completed, the tube furnace was heated from the room temperature of 30° C. to 500° C. at a heating rate of 5° C./minute under the same ventilation condition, the temperature was held for 24 hours, and then cooling was performed at a cooling rate of 2° C./minute; and
(7) after the cooling was completed, the flange at one end of the quartz tube was detached, and the crucible was taken out to obtain the solid electrolyte Li_{3.8}Sn_{0.8}Si_{0.2}S₄.

The solid electrolyte Li_{3.8}Sn_{0.8}Si_{0.2}S₄ obtained in this example has good air stability. After being exposed to and absorbing water in moist air, the solid electrolyte Li_{3.8}Sn_{0.8}Si_{0.2}S₄ can be heated to remove water/crystal water, thereby restoring an original crystal structure.

The components and electrochemical properties of sulfide solid electrolytes Li₄SnS₄Li_{3.85}Sn_{0.85}Sb_{0.15}S₄, Li_{3.8}Sn_{0.8}As_{0.2}S₄, and Li₄Sn_{0.9}Si_{0.1}S₄, of the Li—Sn—S system, prepared according to Examples 1, 2, 3 and 4 were characterized using many test methods, with the results as below.
1. The products obtained in Examples 1, 2, 3, and 4 were determined by X-ray diffraction using Cu—K_{α} rays with a wavelength of 1.5418 angstroms, with the results as shown in FIG. 4. From the figure, it can be seen that the XRD results of the products obtained in Examples 1, 2, 3 and 4 are consistent with the main peaks of the PDF card, and these products pertain to the Pnma(No. 62) space group of the orthorhombic crystal system, and are Li—Sn—S system crystalline materials. Li₄SnS₄ prepared in Example 1 contains Li₂SnS₃ as an impurity phase, which disappears after doping, whereby the purity is increased.
2. 150 mg of the electrolyte material was pressed into a cake under a pressure of 800 MPa by using a pressure mold. A test battery with a C/SSE/C sandwich structure was assembled by using a simulated battery case. On a Zahniumpro electrochemical workstation, the test battery was tested, with perturbations of 5-20 mV, for an alternating-current impedance spectrum in a frequency range of 100 mHz-8 MHz. The results were displayed in the form of a −Nyquist diagram as shown in FIG. 5. The thickness of the electrolyte sheet was measured by using a micrometer caliper, and the diameter of the electrolyte sheet was equal to the diameter of the mold, which was 10 mm. According to a conductivity formula, the ionic conductivities of Li₄SnS₄, Li_{3.85}Sn_{0.85}Sb_{0.15}S₄, Li_{3.8}Sn_{0.8}As_{0.2}S₄, and Li₄Sn_{0.9}Si_{0.1}S₄ were calculated as 4.75×10⁻⁵ S/cm⁻¹, 1.62×10⁻⁴ S/cm⁻¹, 1.66×10⁻³ S/cm⁻¹, and 1.68×10⁻⁵ S/cm⁻¹, respectively.
3. The test battery described in Result 2 was put into a high/low-temperature precise control cabinet to allow alternating-current impedance tests at different temperatures, thereby measuring impedance values at respective temperature points. Then, the ionic conductivity was calculated for plotting Arrhenius curves. From FIG. 6, it can be seen that the activation energies of the electrolytes prepared in Examples 1 and 2 are 0.453 eV and 0.425 eV, respectively.

### Example 5

In this example, low-cost Li₂CO₃, CS₂, SnO₂, and P₂O₅ that had been commercialized were selected as a lithium (Li) source, a sulfur (S) source, a tin (Sn) source, and a phosphorus (P) source, respectively, to synthesize a sulfide electrolyte Li₁₀SnP₂S₁₂. The specific steps were as follows:
(1) Li₂CO₃, SnO₂, and P₂O₅ were weighed out as raw materials according to a desired ratio, and were ground for 30 minutes in a mortar to obtain powder with a total mass of 1 g, and the powder was put into an alumina crucible;
(2) 80 mL of a CS₂ liquid was added to a gas-washing bottle with a capacity of 100 mL;
(3) the crucible containing the raw materials in step (1) was put into the center of a quartz tube of a tube furnace, directly opposing a thermocouple;
(4) a nitrogen cylinder, a gas flow meter, the gas washing bottle, the tube furnace, and a tail gas bottle were connected in sequence by using silicone hoses, and both ends of the quartz tube of the tube furnace were each connected with a flange;
(5) a knob of the gas flow meter was adjusted to regulate the ventilation rate to 10 mL/minute, and gas washing was performed for about 60 minutes in advance;
(6) after the gas washing in step (5) was completed, the tube furnace was heated from the room temperature of 30° C. to 500° C. at a heating rate of 5° C./minute under the same ventilation condition, the temperature was held for 24 hours, and then the furnace was cooled naturally; and
(7) after the cooling was completed, the flange at one end of the quartz tube was detached, and the crucibles were taken out to obtain the solid electrolyte Li₁₀SnP₂S₁₂.

The components of Li₁₀SnP₂S₁₂ prepared in Example 5 were characterized with the results as below.

The obtained product Li₁₀SnP₂S₁₂ was determined by X-ray diffraction using Cu—K_{α} rays with a wavelength of 1.5418 angstroms, with the results as shown in FIG. 7. A high/low-temperature EIS test was performed on the electrolyte to obtain EISs corresponding to different temperature points. The ionic conductivity corresponding to each temperature point was calculated from the ionic conductivity calculation formula and the measured thickness and area of the electrolyte, whereby the ionic conductivities were fitted to obtain an Arrhenius curve as shown in FIG. 8, and the activation energy was calculated finally.

### Example 6

This example provides the process of preparing the raw material Li₂S for the sulfide electrolyte by using a method for gas phase synthesis. Low-cost Li₂CO₃ and CS₂ that had been commercialized were selected as a lithium (Li) source and a sulfur (S) source, respectively, to synthesize a currently expensive raw material Li₂S for the sulfide electrolyte. The specific steps were as follows:
(1) Li₂CO₃ powder with the total mass of 1 g was put in an alumina crucible;
(2) 80 mL of a CS₂ liquid was added to a gas-washing bottle with a capacity of 100 mL;
(3) the crucible containing the raw materials in step (1) was put into the center of a quartz tube of a tube furnace, directly opposing a thermocouple;
(4) a nitrogen cylinder, a gas flow meter, the gas washing bottle, the tube furnace, and a tail gas bottle were connected in sequence by using silicone hoses, and both ends of the quartz tube of the tube furnace were each connected with a flange;
(5) a knob of the gas flow meter was adjusted to regulate the ventilation rate to 10 mL/minute, and gas washing was performed for about 60 minutes in advance;
(6) after the gas washing in step (5) was completed, the tube furnace was heated from the room temperature of 30° C. to 500° C. at a heating rate of 5° C./minute under the same ventilation condition, the temperature was held for 24 hours, and then cooling was performed at a cooling rate of 2° C./minute; and
(7) after the cooling was completed, the flange at one end of the quartz tube was detached, and the crucibles were taken out to obtain the raw material Li₂S for the solid electrolyte.

The components of Li₂S prepared in this example were characterized with the results as below.

The obtained product Li₂S was determined by X-ray diffraction using Cu—K_{α} rays with a wavelength of 1.5418 angstroms, with the results as shown in FIG. 9. Compared with the PDF card 65-2981 of Li₂S, except for the peak at 21.5° which was from a PE film protective material used in the XRD test, the remaining 8 diffraction peaks are in one-to-one correspondence.

### Example 7

This example provides the specific application of the solid electrolyte Li_{3.8}Sn_{0.8}As_{0.2}S₄ prepared in Example 3 to an electrode material.

In this example, Li_{3.8}Sn_{0.8}As_{0.2}S₄ synthesized in Example 3 was taken as a solid electrolyte, LiCoO₂ coated with LiNbO₂ was taken as a positive-electrode active material, Li₄Ti₅O₁₂ was taken as a negative-electrode active material, and a carbon nano-tube (VGCF) was taken as a conductive additive. A lithium battery was prepared according to the method including the steps below.
(1) Li₄Ti₅O₁₂ as the active material, Li_{3.8}Sn_{0.8}As_{0.2}S₄ as the solid electrolyte, and VGCF as the conductive additive were weighed out by mass according to a desired ratio, then ground in a mortar, and mixed into a negative electrode material.
(2) LiCoO₂ as the active material, Li_{3.8}Sn_{0.8}As_{0.2}S₄ as the solid electrolyte, and VGCF as the conductive additive were weighed out by mass according to a desired ratio, then ground in a mortar, and mixed into a positive electrode material.
(3) 2.5 mg of the negative electrode material was weighed out and put into a battery mold, and the surface of a powder layer was smoothed using a stainless steel mold; then, 100 mg of the solid-electrolyte material Li_{3.8}Sn_{0.8}As_{0.2}S₄ was weighed out and put into the battery mold, and the surface of a powder layer was smoothed using the stainless steel mold; and 2 mg of the positive electrode material was weighed out and put into the battery mold, and the surface of a power layer was smoothed using the stainless steel mold. The pressure applied to the entire battery was increased to 30 MPa by using a pressing machine, screws were tightened, and the battery was sealed by applying vacuum silicone grease so as to isolate moist and oxygen in the air.
(4) The battery was connected to a LAND test channel, and a charge/discharge cycle program was set to charge and discharge the battery at a rate of 0.1C. Initial-cycle charge/discharge curves are shown in FIG. 10, in which an all-solid-state powder battery assembled from the electrolyte Li_{3.8}Sn_{0.8}As_{0.2}S₄ shows an initial-cycle discharge capacity up to and an initial-cycle coulombic efficiency of 79.11%.

The method for gas phase synthesis of the sulfide solid-electrolyte material according to the disclosure uses air-stable and low-cost raw materials to synthesize the sulfide solid-electrolyte material and the raw material thereof in one step by a gas phase method, greatly simplifying the process steps and the operating complexity and showing low requirements for synthesis equipment. The method is suitable for large-scale process production. In the method for synthesis of the sulfide solid-electrolyte material, due to the use of air-stable raw materials and the good air stability of the synthesized sulfide solid-electrolyte material, the method for synthesis does not need to be performed under the condition of a vacuum environment or with the protection of an inert atmosphere, and can be performed directly in an air environment (moist air and dry air in a dry room), such that the air stability is achieved throughout the process of preparing the sulfide solid-electrolyte material from raw materials to a final reaction product, and the compatibility with the existing process lines and equipment for producing lithium batteries in a dry room environment is achieved. Further, the disclosure fundamentally solves the problem of strict requirements for the environmental atmosphere during production and preparation, storage, transportation, and usage of the sulfide solid-electrolyte materials, greatly promoting the application of the sulfide solid-electrolyte materials.

The objects, technical solutions and advantageous effects of the disclosure are further illustrated in detail with the specific embodiments described above. It should be understood that the description above only involves the specific embodiments of the disclosure and is not intended to limit the protection scope of the disclosure. Any modifications, equivalent substitutions, improvements and the like made within the spirit and principle of the present invention shall be construed as being included within the protection scope of the disclosure.

1. A method of gas phase synthesis for a sulfide solid-electrolyte material, comprising:
weighing a Li source and an M source, as raw materials, according to a desired ratio, then mixing the Li source and the M source, and putting the mixed raw materials into a heating furnace, wherein the Li source comprises at least one of Li₂CO₃, Li₂O, Li₂S, LiOH, LiCl, lithium acetate, lithium sulfate, lithium nitrate, or lithium metal, and the M source comprises at least one of an elementary substance of an M element, an oxide of the M element, and a sulfide of the M element, with the M element being at least one element selected from elements of Groups 4, 5, 6, 13, 14, and 15 in the periodic table of the elements from Period 3 to Period 6;
adding an S source to a sulfur-source gas generation device, wherein the S source comprises one or more of an S-containing gas, a sulfur-containing organic compound, a polysulfide, a sulfate, or a metal sulfide;
connecting a carrier gas generation device, a gas flow meter, the sulfur-source gas generation device, the heating furnace, and a tail gas treatment device in sequence to form a gas phase synthesis device;
carrying a gas containing the S source by a carrier gas, and performing gas washing on the heating furnace for a certain period of time at a set ventilation rate;
after the gas washing is completed, heating the heating furnace to 200° C.-800° C. at a set heating rate in an environment in which the gas containing the S source is introduced at the set ventilation rate, holding the temperature for a set period of time, and then cooling to room temperature; and
after the cooling, removing a sulfide solid electrolyte from the heating furnace.

2. The method of claim 1 wherein:
the M element comprises at least one of Sn, Sb, As, P, Si, Ge, and Bi;
the M source comprises at least one of an Sn source, an Sb source, an As source, and a P source;
the Sn source comprises at least one of elemental Sn, SnO₂, SnS₂, SnCl₄, and their hydrates;
the Sb source comprises at least one of elemental Sb, Sb₂O₅, Sb₂O₃, Sb₂S₅, and Sb₂S₃;
the As source comprises at least one of elemental As, As₂O₅, As₂O₃, As₂S₅, and As₂S₃;
the P source comprises at least one of elemental P, P₂S₃, P₂S₅, and P₂O₅;
an Si source comprises at least one of elemental Si, SiO, SiO₂, SiS₂, SiCl₄, and hydrates thereof;
a Ge source comprises at least one of elemental Ge, GeO₂, GeS, GeS₂, GeCl₄, and hydrates thereof;
a Bi source comprises at least one of elemental Bi, Bi₂O₃, Bi₂S₃, and Bi(OH)₃;
the S-containing gas comprises at least one of hydrogen sulfide, sulfur dioxide, sulfur trioxide, sulfur-containing natural gas, sulfur vapor, and carbon disulfide vapor;
the sulfur-containing organic compound comprises at least one of methyl mercaptan, methyl sulfide, dimethyl disulfide, thiophene, ethanethiol, ethyl sulfide, methyl ethyl sulfide, and thiourea; and
the carrier gas comprises any one of N₂, CO₂, and an Ar gas.

3. The method of claim 1, wherein a method for the mixing comprises:
mortar grinding or mechanical mixing;
a time for the mortar grinding is in a range from 10 minutes to 120 minutes; and
the mechanical mixing comprises performing mechanical mixing by using a roller mill, a ball mill, or a spray mill, for a mixing time in a range of 1 hour to 8 hours.

4. The method of claim 1, wherein:
the certain period of time is in a range from 10 minutes to 120 minutes;
the set period of time is in a range from 10 hours to 72 hours;
the set heating rate is in a range from 1° C./min minute to 10° C./minute;
the cooling is performed at a set cooling rate, or by natural cooling, with the set cooling rate being in a range from 1° C./minute to 10° C./minute; and
the set ventilation rate is in a range from 1 ml/minute to 30 ml/minute.

5. A method for gas phase synthesis of a raw material for a sulfide solid-electrolyte material, the method comprising:
weighing out an A source according to a desired amount, and then putting the A source into a heating furnace, the A source including at least one of an oxide of A, a hydroxide of A, a carbonate of A, and elemental A;
adding an S source to a sulfur-source gas generation device, wherein the S source comprises one or more of an S-containing gas, a sulfur-containing organic compound, a polysulfide, a sulfate, or a metal sulfide;
connecting a carrier gas generation device, a gas flow meter, the sulfur-source gas generation device, the heating furnace, and a tail gas treatment device in sequence to form a gas phase synthesis device;
carrying a gas containing the S source by a carrier gas, and performing gas washing on the heating furnace for a certain period of time at a defined ventilation rate;
after the gas washing is completed, heating the heating furnace to 200° C.-800° C. at a set heating rate in an environment in which the gas containing the S source is introduced at a set ventilation rate, holding the temperature for a set period of time, and then cooling to room temperature; and
after the cooling, removing the raw material for the sulfide solid electrolyte, from the heating furnace, wherein the raw material has a chemical formula of AₓS_{y}, with A being any one of Li, Si, Ge, Sn, P, As, Sb, and Bi, 0<x≤2, and 0<y≤5.

6. The method of claim 5, wherein:
the carrier gas comprises any one of N₂, CO₂, and an Ar gas;
the S-containing gas comprises at least one of hydrogen sulfide, sulfur dioxide, sulfur trioxide, sulfur-containing natural gas, sulfur vapor, and carbon disulfide vapor; and
the sulfur-containing organic compound comprises at least one of methyl mercaptan, methyl sulfide, dimethyl disulfide, thiophene, ethanethiol, ethyl sulfide, methyl ethyl sulfide, and thiourea.

7. The method of claim 5, wherein:
the certain period of time is in a range from 10 minutes to 120 minutes;
the set period of time is in a range from 10 hours to 72 hours;
the set heating rate is in a range from 1° C./minute to 10° C./minute;
the cooling is performed at a set cooling rate, or by natural cooling, with the defined cooling rate being in a range from 1° C./minute to 10° C./minute; and
the set ventilation rate is in a range from 1 ml/minute to 30 ml/minute.

8. A sulfide solid-electrolyte material synthesized based on the of claim 1, wherein the sulfide solid-electrolyte material is used as an electrode material of a lithium battery.

9. A raw material for a sulfide solid-electrolyte material synthesized using the method of claim 5, wherein the raw material is used for synthesizing the sulfide solid-electrolyte material and the sulfide solid-electrolyte material is used as an electrode material of a lithium battery.

10. A lithium battery, comprising the sulfide solid-electrolyte material synthesized by the method for gas phase synthesis of claim 1.
